(19) United States
(12) Patent Application Publication
(10) Pub. No.: US 2010/0272959 A1
(43) Pub. Date: Oct. 28, 2010

(54) METHOD AND UNIT FOR MICRO-STRUCTURING A MOVING SUBSTRATE

(75) Inventor: Karl Boehlen, Winterthur (CH)

Correspondence Address: PEARNE & GORDON LLP, 1801 EAST 9TH STREET, SUITE 1200, CLEVELAND, OH, 44114-3108, US

(73) Assignee: OERLIKON BALZERS COATING (UK) LIMITED, Tilbrook, Milton Keynes (GB)

(21) Appl. No.: 12/301,814

(22) PCT Filed: May 15, 2007
(86) PCT No.: PCT/GB2007/001815

§ 371 Date: Jul. 15, 2009

(30) Foreign Application Priority Data
May 24, 2006 (GB) 0610319.6

(51) Int. Cl. B29C 35/08; B32B 3/30

(52) U.S. Cl. 428/156; 264/400; 425/150

(57) ABSTRACT

A method for exposing a polymer or other substrate (S) to patterned illumination from a pulsed laser source (12) at a suitable energy density in order to cause ablation of the surface to form a dense, regular array of 2-D or 3-D microstructures, characterised by the steps of: locating a mask (13) containing a series of identical or different features on a fixed pitch relative to a target area (14) of the substrate (S); projecting a uniform laser beam (18) through the mask (13) in order to project an image made up of a multiplicity of the features of the mask (13) onto the target area (14), de-magnifying the image carried by the beam (18) between the mask (13) and the target area (14); locating a substrate (S) for ablation in the target area (14);

moving the substrate (S), at least while in the target area, in a first direction (D1) parallel to one axis of the projected array of microstructures and also in a second direction (D2) perpendicular to the first direction; and controlling (20) the firing of the pulsed laser (12) in relation to the exact position of the substrate (S) in the target area 14).

The invention further comprises a unit for ablating the surface of a polymer or other substrate (S) to form a dense, regular array of 2D or 3D microstructures by patterned illumination comprising: a pulsable laser source (12); a mask (13) containing a series of identical or different features on a fixed pitch and disposed between the laser source (12) and a target area (14); an illumination system (15) for creating a uniform laser beam (16) that exposes a multiplicity of the features on the mask (13) and disposed between the laser source (12) and the mask (13); an optical projection system (17) to de-magnify the mask image onto the target area (12) and disposed between the mask (13) and the target area (12); a 2-axis stage system (19) for the substrate (s) adapted to move the substrate (S) in the target area (14) in a first direction parallel to one axis of the regular array of microstructures and also in a second direction perpendicular to the first direction; and a control system (20) that links the firing of the pulsed laser (12) to the exact position of the substrate (S) in the target area (14).

### TECHNICAL FIELD

The present invention is concerned with laser ablation technology for the formation of 3-D structures on the surface of materials.

More particularly it relates to improvements made to laser mask projection ablation processes for the creation of dense repeating 3-D microstructures on the surface of a polymer or other substrate of large size.

### BACKGROUND ART

The methods of pulsed laser ablation by mask projection are well known. The beam from a laser is passed through optics to make it as uniform as possible at the surface of a mask. The image of the mask is projected onto the surface of the substrate to be structured by use of a projection lens. This lens generally de-magnifies the mask image so that the energy density of each pulse of laser radiation landing on the substrate surface exceeds the threshold for ablation. The lasers used for this process are generally Excimer lasers operating in the UV region but it is also possible to carry out the same technique using pulsed lasers operating at longer wavelengths. Generally many laser shots are needed to create a structure of the required depth.

There exists a requirement to use this technique to create large area repeating 2-D and 3-D microstructures on the surface of a substrate. For 2-D structures the mask remains the same for the full set of exposures but to create a 3-D microstructure of exactly the desired shape it is necessary to change the mask after each laser shot to correspond to the correct contour of the microstructure. Such a step and repeat process is very slow if microstructures are processed one by one especially if the microstructures are small and the substrate is large. A typical requirement might be to create an array of 0.1×0.1 mm structures on the surface of a 1×1 m substrate. In this case 100 million individual structures would be required. If the laser has sufficient pulse energy then multiple structures can be processed on each shot but for a 3-D structure the mask still needs to be changed between shots and so the process is still relatively slow. With a typical laser it is generally possible to create an image with an area over 10 mm² which means that over 1000 microstructures of 0.1 mm size can be exposed each shot. This speeds the process significantly but such a step and repeat process leads to matching problems at the image boundaries generally caused by non-uniformity of the laser beam, deposition of ablated debris and errors in accuracy of stage movement.

One way to overcome this has been described in EP 0 822 881 in which the substrate was not stepped by the full field of the image after complete processing of this area but was stepped after each laser shot by a distance less than the full field corresponding to the pitch (or multiple of the pitch) of the microstructures to be formed. The mask contains a series of identical apertures spaced at the correct pitch for the case where a simple 2-D structure is required but for the case where a 3-D structure is required the mask contains a series of different apertures each corresponding to a different contour of the 3-D structure to be formed.

By stepping the substrate a distance equal to an integral number of microstructure pitches, after the complete passage of the substrate under the beam all or part of the 3-D structure is created as each area of the substrate is exposed to the full range of different mask apertures corresponding to the different depth contours. This technique is very effective in overcoming problems associated with lack of uniformity of the beam leading to differences in depth of structure but suffers from three major problems: low process speed, poor surface smoothness and ‘stitching’ effects arising at the boundaries between image fields especially when convex structures are machined. The first of these arises due to the step and repeat nature of the process, the second arises due to the finite depth of ablation on each laser shot causing micro steps on the surface of the microstructure and the third is due to the positive taper angle that occurs on the side wall of ablated structures that are nominally vertical and also due to deposition of ablated material. The present invention seeks to overcome these three problems.

### DISCLOSURE OF INVENTION

According to a first aspect of the present invention there is provided a method for exposing a polymer or other substrate (S) to patterned illumination from a pulsed laser source (12) at a suitable energy density in order to cause ablation of the surface to form a dense, regular array of 2-D or 3-D microstructures, characterised by the steps of:
locating a mask (13) containing a series of identical or different features on a fixed pitch relative to a target area (14) of the substrate (S);
projecting a uniform laser beam (18) through the mask (13) in order to project an image made up of a multiplicity of the features of the mask (13) onto the target area (14),
de-magnifying the image carried by the beam (18) between the mask (13) and the target area (14);
locating a substrate (S) for ablation in the target area (14);
moving the substrate (S), at least while in the target area, in a first direction (D1) parallel to one axis of the projected array of microstructures and also in a second direction (D2) perpendicular to the first direction; and
controlling (20) the firing of the pulsed laser (12) in relation to the exact position of the substrate (S) in the target area 14).

According to a first preferred version of the first aspect of the present invention is characterised by the step of moving the substrate (S) is carried out continuously without stopping with respect to the projected image and the step of controlling the firing of the pulsed laser (12) provides for firing whenever the substrate (S) has moved a distance equal to an integral number of pitches of the microstructures forming the array.

According to a second preferred version of the first aspect of the present invention or of the first preferred version thereof the method is characterised in that the step of locating the mask involves a mask (14) in which some or all of the apertures (11′-15′) comprise half tone structures.

According to a third preferred version of the first aspect of the present invention or of any preceding preferred version thereof characterised in that the steps of projecting and de-magnifying serves to create a high enough laser beam (18) angle at the image plane, in the axis perpendicular to the first and second directions so as to avoid the creation at side edges of projected rows of convex microstructures of ridges when parallel rows of structures are formed adjacent to each other.

According to a fourth preferred version of the first aspect of the present invention or of any preceding preferred version thereof the method is characterised in that for the projecting step the mask (13) has side edges that are both tilted with respect to the row of features in the mask in order to create sloping sides to the projected rows of convex microstructures formed so that when rows are placed next to each other these sloping sides exactly overlap and no ridges or troughs are created at the boundary.

According to a second aspect of the present invention there is provided a unit for ablating the surface of a polymer or other substrate (S) to form a dense, regular array of 2D or 3D microstructures by patterned illumination comprising:
a pulsable laser source (12);
a mask (13) containing a series of identical or different features on a fixed pitch and disposed between the laser source (12) and a target area (14);
an illumination system (15) for creating a uniform laser beam (16) that exposes a multiplicity of the features on the mask (13) and disposed between the laser source (12) and the mask (13);
an optical projection system (17) to de-magnify the mask image onto the target area (12) and disposed between the mask (13) and the target area (12);
a 2-axis stage system (19) for the substrate (s) adapted to move the substrate (S) in the target area (14) in a first direction parallel to one axis of the regular array of microstructures and also in a second direction perpendicular to the first direction; and
a control system (20) that links the firing of the pulsed laser (12) to the exact position of the substrate (S) in the target area (14).

According to a first preferred version of the second aspect of the present invention the unit is characterised by a 2-axis stage system is enabled to driven to drive the substrate (S) continuously with respect to the projected image and the control system (20) causes the laser source (12) to fire whenever the substrate (S) has been moved a distance equal to an integral number of pitches of the microstructures forming the array.

According to a second preferred version of the second aspect of the present invention or of the first preferred version thereof the unit is characterised in that some or all of the apertures in the mask (13) half tone structures.

According to a third preferred version of the second aspect of the present invention or of any preceding preferred version thereof the optical mask illumination (15) and projection system (17) creates high enough laser beam angles at the image plane on the substrate (S), in an axis perpendicular to the first or second directions, to create a vertical wall at the side edges of rows of convex microstructures such that there are no ridges created when parallel rows of structures are formed adjacent to each other.

According to a fourth preferred version of the second aspect of the present invention or of any preceding preferred version thereof the optical mask (13) has side edges that are both tilted with respect to the row of features in the mask (13) in order to create sloping sides to the rows of convex microstructures formed so that when rows are projected next to each other the images of the sloping side overlap and no ridges or troughs are created at the boundary between the rows.

According to a third aspect of the present invention there is provided a substrate product fabricated by a method of the first aspect.

According to a fourth aspect of the present invention there is provided a substrate product fabricated by a unit of the second aspect.

The present invention provides a method and apparatus for exposing a substrate to regularly patterned radiation to create a series of 2D and 3D structures on the surface of a substrate by direct laser ablation as described in EP0822881 but unlike that invention the final product is created at high speed with a smooth surface to the microstructure and with minimal ridge or seam effects at the boundaries between ablation bands

### BRIEF DESCRIPTION OF DRAWING

An exemplary embodiment of the invention will now be described with reference to the accompanying drawings relating to a unit for ablating the surface of a polymer or other substrate of which:

FIG. 1 is a diagram showing component layout;

FIG. 2 is a diagram of alternative forms of ablation obtainable;

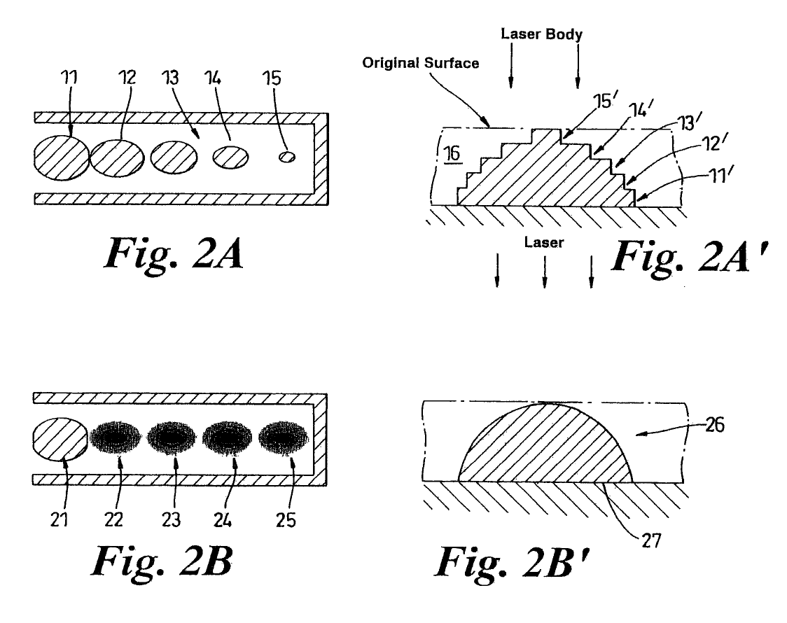

FIG. 3 is a diagram of a way of mitigating a possible seam effect of micro structuring.

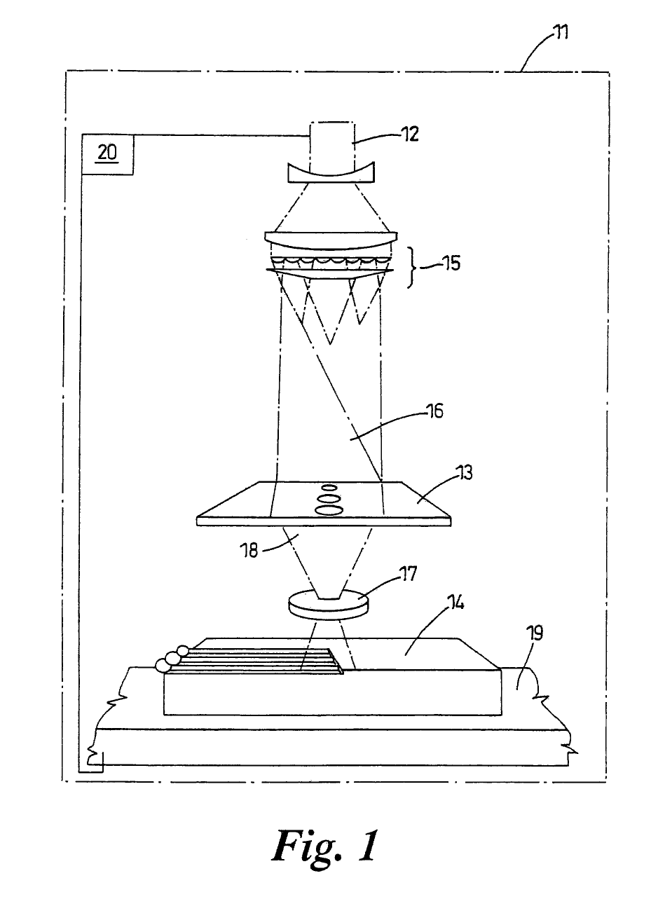

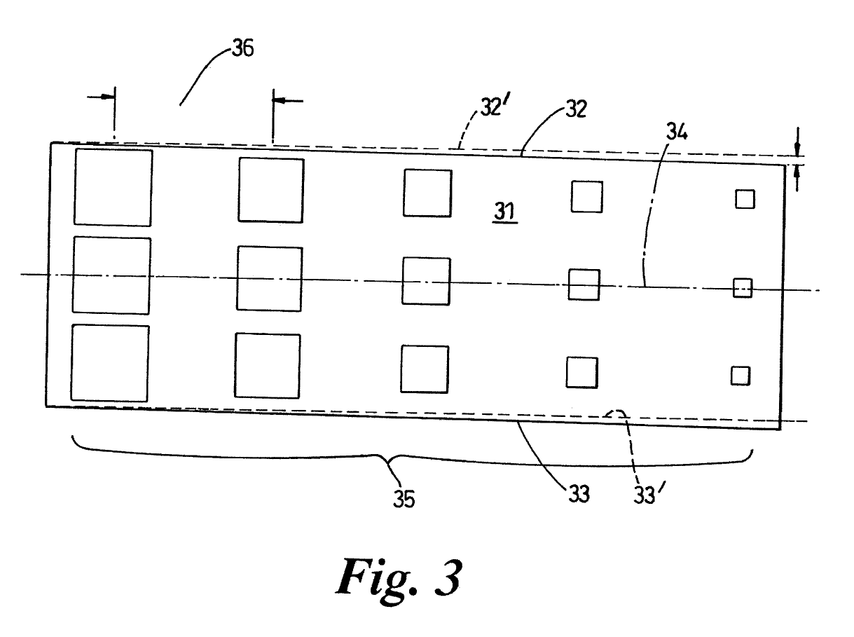

### FIG. 1

A unit 11 including a pulsable laser source 12. A mask 13 contains a series of identical or different features on a fixed pitch and disposed between the laser source 12 and a target area 14.

An illumination system 15 serves to create a uniform laser beam 16 that exposes a multiplicity of the features on the mask 13.

An optical projection system 17 serves to de-magnify the beam 18 and so provide for a reduced scale image of the mask image onto substrate S located in the target area 14 by means of a 2-axis stage system 19 that serves to move the substrate S through the target area 14 in a first direction D1 parallel to one axis of the regular array of microstructures and also in a second direction D2 perpendicular to the first direction. Both directions D1 and D2 are perpendicular to the beam 18.

Control system 20 serves to govern the firing of the pulsed laser source 12 to the exact position of the substrate S established by stage system 19.

### MODES FOR CARRYING OUT THE INVENTION

In this invention the ablation process is performed rapidly by eliminating the step and repeat nature of existing processes and operating with the substrate continuously moving in a direction exactly parallel to one of the axes of the regular microstructure array. For such a process to work effectively the laser firing has to be timed exactly with respect to the stage motion. This means the stages have to have high resolution encoders fitted and to be highly repeatable. It also means that fast and jitter free control electronics are needed to generate laser firing pulses from the stage encoder signals so that small changes in stage speed (due to servo loop control errors) do not affect the exact positioning of the images. We call this process synchronized image scanning (SIS).

For highest speed processing it is preferable that the microstructure is fully complete after a single pass by the beam. This is readily accomplished by using a laser beam that is shaped to form a rectangular beam at the mask and hence a rectangular image. If the substrate is scanned parallel to the long axis of the rectangular image and in this direction the mask contains all the contours corresponding to all the different depths of the microstructure then the structure will be complete after a single continuous pass.

For a microstructure of 0.1 mm in lateral size and beam of 10 mm length 100 different apertures representing 100 different structure contours can be fitted into the image and a single pass will subject each point on the substrate to 100 laser shots. If the substrate is a polymer and the energy density is chosen correctly depths between 0.2 and 0.3 microns can be ablated on each laser shot so that after 100 shots depths between 20 and 30 microns are achieved. Such depths are sufficient for many microstructure requirements but for greater depths greater beam lengths containing a greater number of apertures can be used. An alternative method to achieve greater depth where the image size is insufficient to incorporate all the contours of the 3D structure is to use more than one pass of the beam over the surface with the mask changed between passes. In this case each mask contains a subset of the total number of apertures required to define all the contours of the 3D structure so that after the substrate has been exposed to all the masks each individual 3D microstructure has been exposed to all the different apertures.

It should be noted that the particular temporal order in which the substrate is exposed to the different apertures may affect the surface smoothness of the structure but is not critical to this invention. In some cases it is preferable to expose the substrate to the smallest aperture first followed by increasing apertures. In other cases the opposite is preferable. It is also possible to expose the surface to the apertures in a random order.

If the mask contains a range of different clear or opaque feature sizes to create a complex 3D structure on the surface of the substrate and these features have sharp edges acting as binary masks then the surface of the microstructure is likely to have minute steps on it corresponding to individual laser pulses. This problem is more critical on the regions of the microstructure where the curvature low such as in the centre of a micro-lens. In the present invention this surface irregularity is eliminated by introducing half tone features to at least some and sometimes all of the mask features.

Half tone mask techniques have been used extensively in step and repeat ablation processes in order to generate multi level devices and to create smooth 3D structures. Full information is given in several publications. “Multilevel diffractive optical element manufacture by Excimer laser ablation and half tone masks” (SPIE Proceedings Volume 4274, 2001, p 420) explains the half tone mask concept and demonstrates its use to form multilevel diffractive optical elements in step and repeat mode. “Excimer laser micro-machining of polymers using half tone mask: Mask design and process optimization” (Proceedings of 6th International Symposium on Laser Precision Micro fabrication (LPM 2005, p 215-218) describes the principles of half tone mask design and use for manufacture of smooth 3D and 2D structures in both step and repeat and non-synchronised scanning modes. The present invention proposes the use of these half tone mask techniques in conjunction with the continuous on the fly synchronized image scanning (SIS) technique to create repeating 3D microstructures with high surface quality over large areas at high speed.

The half tone technique does not necessarily need to be applied to all features in the mask design. Its use is critical however where only gradual changes in microstructure depth are required and use of binary masks would show ablation steps on the surface. Half tone mask techniques are particularly critical where concave and convex micro lens arrays are to be manufactured. In this case the clear or opaque features on the mask defining the critical regions of the lens where the surface to be created has only a small angle to the original surface benefit substantially from use of half tone techniques to eliminate the discrete ablation steps on the surface.

For a typical Excimer laser with repetition rate of a few 100 Hz the beam at the image may have an area in the range 10-20 mm². This means that if the beam is 10 to 20 mm long the width will be only 1 or 2 mm and the substrate will be processed in a series of continuous stripes of this width. One problem with this continuous synchronised scanning process for 3D microstructure formation is the stitching errors that occur between adjacent scan bands. Such errors manifest themselves as visible lines on the substrate on a pitch equivalent to the scan width. For concave micro-structures where little or no material is ablated at the edge of the image field these are usually caused by the deposition of debris ablated from an area within the beam landing on a surface yet to be exposed. For convex structures however where material is ablated to the full depth of the micro-structure at the image field edge the visible lines are due to ridges caused by the inward slope to the wall.

The most straight forward method to minimise this boundary problem is to scan only a single line of micro structures on a single pass. In this way even if debris or ridge artefacts occur they are on the same pitch as the smallest structure and therefore are not seen as a defect. For the case considered above the beam would be only 0.1 mm wide by 10 mm long. With a laser firing at 200 Hz and the substrate moving one microstructure pitch between laser shots the stage speed is only 20 mm per sec so the process time to cover a large area will be very long. Hence the ideal laser for large area rapid 3D microstructure formation operates at a high repetition rate. An ideal laser would have modest energy, sufficient to illuminate a narrow rectangular image area at the correct energy density but would generate this at repetition rates of at least 1000 pulses per second. If an image area of 0.1×10 mm is used and an energy density of 5 mJ/mm² (0.5 J/cm²) required then the laser needs to emit energies of several 10 s of mJ per pulse. Such Excimer lasers do exist but are limited in power so that process times are long for large area micro-structures.

### INDUSTRIAL APPLICABILITY

In this invention we propose three methods to eliminate the “taper zone” ridges that occur at the boundaries between scanned areas when convex structures are machined using beams with width equivalent to one or more micro-structure pitches.

In a first approach the optical system is operated in such a way that the taper on the wall at the field edge is effectively zero. Achieving this means no ridges occur at the boundaries between scanned areas. Achieving zero taper angles is possible by correct choice of projection lens numerical aperture coupled to correct design of the beam homogenisation and mask illumination system in order to fill the lens entrance pupil correctly. If these optical matters are correctly controlled the angles of the incident beam at the image on the substrate are sufficiently high that the inward taper angle on the outer sidewalls of the ablated row of structures is reduced to zero and no ridge will be created at the boundary between adjacent rows of structures. It is only necessary to control the lens aperture and illumination angles such as to reduce the ablation taper angle to zero in one axis of the beam at the image so long as this axis is the one that is perpendicular to the beam or substrate scanning direction. The problem with this method however is that in general to achieve zero taper angles in polymer materials requires the use of lenses with relatively high numerical aperture (>0.2) and operation at relatively high energy density. Use of such high aperture lenses means the depth of focus is restricted and process control over large area substrates is difficult. Use of high energy densities is also sometimes undesirable as the efficiency of ablation is lower than at low energy densities.

In a second approach the mask is modified to incorporate a simple increase of the width of the projected image by adding on each side a clear zone equal to the width of the zone caused by the finite taper. By doing this the ridge is eliminated but as the step between process bands must be an exact number of structure pitches and the image width is wider than this then at the overlap point too much material is removed causing a groove between adjacent scan bands. In certain applications this is preferable to a ridge but nevertheless it represents an undesirable discontinuity in the profile.

In a third approach the natural taper is eliminated by modifying the mask pattern such that it incorporates features that expose the surface in the taper region to a series of laser pulses that create a slope exactly equal but opposite to the natural taper. This is most readily achieved by tilting the side boundaries of the mask defining the row (or rows) of microstructures by a small amount with respect to the axis of the features defining the micro-structures on the mask. For the creation of convex microstructures the mask consists of a series of cells spaced on a regular pitch with each cell having an opaque feature inside the cell to define a particular contour in the convex micro-structure. The opaque features increase in size from very small, representing the top surface of the convex feature, to large enough to fully fill the cell, representing the outer boundary or lowest level of the microstructure. This means that at one end of the row of opaque features in the mask, where all opaque areas are small, the mask is almost fully transparent. It is at this “transparent” end of the row of features that the tilt is applied to the two outer side edges of the mask pattern to overcome the taper effect. Applying the tilt to the outer edges in this region of the mask has no effect on the opaque regions since they are small in this area of the mask. The level of tilt applied at the mask edges has to correspond exactly to the natural taper that occurs without any taper correction. For the case where 0.1 mm size microstructures are formed in a polymer such as poly-carbonate to a depth of 25 μm by the use of a beam 10 mm long subjecting the surface of the substrate to 100 different contours the natural ablation angle that occurs at the side edges of the scanned pattern is likely to be in the range of 5 to 10 degrees to the vertical but higher angles are also possible. This means that in this case the lateral width of the natural taper region at the lowest level of the microstructure is likely to be in the range of a few to about 5 microns but higher values are also possible. This means that the tilt applied to the side edges of the mask pattern should lead to a tilt on the side edges of the image of a similar amount. Hence the offset of the side edges at the “transparent” end of the image is of order a few to about 5 microns and hence the edge tilt over the 10 mm beam length amounts to an angle of less than about 0.05 degrees. Higher or lower angles may be required depending on the laser ablation conditions and materials used. When the substrate is moved under the beam in the direction exactly parallel to the row of features on the mask the tilted edges on each side of the image give rise to sloping sidewalls on both sides of the row of structures formed. This edge tilt taper correction is applied equally to both sides of the mask pattern with both tilt angles in the same direction with respect to the axis of the scanning direction. Hence when the substrate is moved sideways by an amount exactly equal to a single or multiple number of pitch distances and a parallel row of structures is created the sloping sidewalls on each side of the rows exactly overlap so that no ridge or trough is formed at the boundary.

1. A method for exposing a polymer or other substrate (S) to patterned illumination from a pulsed laser source (12) at a suitable energy density in order to cause ablation of the surface to form a dense, regular array of 2-D or 3-D microstructures, characterised by the steps of:
locating a mask (13) containing a series of identical or different features on a fixed pitch relative to a target area (14) of the substrate (S);
projecting a uniform laser beam (18) through the mask (13) in order to project an image made up of a multiplicity of the features of the mask (13) onto the target area (14),
de-magnifying the image carried by the beam (18) between the mask (13) and the target area (14);
locating a substrate (S) for ablation in the target area (14);
moving the substrate (S), at least while in the target area, in a first direction (D1) parallel to one axis of the projected array of microstructures and also in a second direction (D2) perpendicular to the first direction; and
controlling (20) the firing of the pulsed laser (12) in relation to the exact position of the substrate (S) in the target area 14).

2. A method as claimed in claim 1 for exposing a substrate (S) characterised in that the step of moving the substrate (S) is carried out continuously without stopping with respect to the projected image and the step of controlling the firing of the pulsed laser (12) provides for firing whenever the substrate (S) has moved a distance equal to an integral number of pitches of the microstructures forming the array.

3. A method as claimed in claim 1 or claim 2 characterised in that the step of locating the mask involves a mask (14) in which some or all of the apertures (11′-15′) comprise half tone structures.

4. A method as claimed in any preceding claim characterised in that the steps of projecting and de-magnifying serves to create a high enough laser beam (18) angle at the image plane, in the axis perpendicular to the first and second directions so as to avoid the creation at side edges of projected rows of convex microstructures of ridges when parallel rows of structures are formed adjacent to each other.

5. A method as claimed in any preceding claim characterised in that for the projecting step the mask (13) has side edges that are both tilted with respect to the row of features in the mask in order to create sloping sides to the projected rows of convex microstructures formed so that when rows are placed next to each other these sloping sides exactly overlap and no ridges or troughs are created at the boundary.

6. A unit for ablating the surface of a polymer or other substrate (S) to form a dense, regular array of 2D or 3D microstructures by patterned illumination comprising:
a pulsable laser source (12);
a mask (13) containing a series of identical or different features on a fixed pitch and disposed between the laser source (12) and a target area (14);
an illumination system (15) for creating a uniform laser beam (16) that exposes a multiplicity of the features on the mask (13) and disposed between the laser source (12) and the mask (13);
an optical projection system (17) to de-magnify the mask image onto the target area (12) and disposed between the mask (13) and the target area (12);
a 2-axis stage system (19) for the substrate (s) adapted to move the substrate (S) in the target area (14) in a first direction parallel to one axis of the regular array of microstructures and also in a second direction perpendicular to the first direction; and
a control system (20) that links the firing of the pulsed laser (12) to the exact position of the substrate (S) in the target area (14).

7. A unit as claimed in claim 6 where the 2-axis stage system is enabled to driven to drive the substrate (S) continuously with respect to the projected image and the control system (20) causes the laser source (12) to fire whenever the substrate (S) has been moved a distance equal to an integral number of pitches of the microstructures forming the array.

8. A unit as claimed in claim 6 or claim 7 wherein some or all of the apertures in the mask (13) half tone structures.

9. A unit as claimed in any of claims 6 to 8 wherein the optical mask illumination (15) and projection system (17) creates high enough laser beam angles at the image plane on the substrate (S), in an axis perpendicular to the first or second directions, to create a vertical wall at the side edges of rows of convex microstructures such that there are no ridges created when parallel rows of structures are formed adjacent to each other.

10. A unit as claimed in any of preceding claims 6 to 9 wherein the optical mask (13) has side edges that are both tilted with respect to the row of features in the mask (13) in order to create sloping sides to the rows of convex microstructures formed so that when rows are projected next to each other the images of the sloping side overlap and no ridges or troughs are created at the boundary between the rows.

11. A substrate product fabricated by the method of claims 1 to 5.

12. A substrate fabricated by apparatus as claimed in claims 6 to 10
